(19) United States
(12) Patent Application Publication
(10) Pub. No.: US 2023/0350403 A1
(43) Pub. Date: Nov. 2, 2023

(54) SYSTEMS AND METHODS FOR MOVEMENT CONTROL IN MULTI-DEVICE ENVIRONMENTS

(71) Applicant: Apple Inc., Cupertino, CA (US)

(72) Inventors: Pekka Tapani RAIKO, Zurich (CH); Sebastian BRECHTEL, Zurich (CH); Enric GALCERAN, Mellen (CH)

(21) Appl. No.: 18/174,564

(22) Filed: Feb. 24, 2023

Related U.S. Application Data
(60) Provisional application No. 63/363,923, filed on Apr. 29, 2022.

(51) Int. Cl. G05D 1/00; G06V 20/58; G06T 7/20

(52) U.S. Cl. CPC G05D 1/00; G06V 20/58; G06T 7/20; G06T 2207/30241

(57) ABSTRACT

An electronic device performs one or more maneuvers in an environment including a second electronic device in accordance with some embodiments. In some embodiments, the electronic device predicts a change in acceleration of the second device caused by the first device performing a maneuver and performs the maneuver if the predicted change in acceleration satisfies one or more criteria and forgoes the maneuver if the predicted change in acceleration does not satisfy the one or more criteria. In some embodiments, while performing a maneuver as part of a movement algorithm of the electronic device, the electronic device senses data indicative of a change in acceleration of a second electronic device and updates the movement algorithm in accordance with the change in acceleration of the second electronic device satisfying one or more second criteria.

### CROSS-REFERENCE TO RELATED APPLICATIONS

This application claims the benefit of U.S. Provisional Application No. 63/363,923, filed Apr. 29, 2022, the content of which is incorporated herein by reference in its entirety for all purposes.

### FIELD OF THE DISCLOSURE

Aspects of the present disclosure relate to systems and methods for controlling movement at a mobile device in an environment with other mobile devices.

### BACKGROUND OF THE DISCLOSURE

A mobile device may include one or more sensors to capture information within a field of view, and may apply the sensed information during system planning and execution of device commands.

### SUMMARY OF THE DISCLOSURE

In some situations, the sensed information further informs mobile device maintenance and servicing opportunities. Implementations described and claimed herein address the foregoing by providing systems and methods for servicing mobile devices.

In some embodiments, an electronic device operates in an environment including a second electronic device. The electronic device can sense, using one or more sensors, data indicative of acceleration of the second electronic device and can estimate a change in acceleration of the second device that will be caused by the electronic device performing a maneuver. In some embodiments, the first device can perform the maneuver in accordance with a determination that the predicted change in acceleration of the second device satisfies one or more criteria and can forgo performing the maneuver in accordance with a determination that the change in acceleration does not satisfy the one or more criteria.

In some embodiments, an electronic device performs one or more maneuvers according to a movement algorithm. In some embodiments, while the electronic device moves according to the movement algorithm, the electronic device senses, using one or more sensors, data indicative of a change in acceleration of a second electronic device. In some embodiments, in accordance with the change in acceleration satisfying one or more criteria, the electronic device updates the movement algorithm.

While the foregoing and additional implementations are described herein, still other implementations are possible. Modifications within the spirit and scope of the presently disclosed technology are possible. Accordingly, the drawings and detailed description are to be regarded as illustrative in nature.

### BRIEF DESCRIPTION OF THE DRAWINGS

For a better understanding of the various described embodiments, reference should be made to the Detailed Description below, in conjunction with the following drawings in which like reference numerals often refer to corresponding parts throughout the figures.

FIG. 1 illustrates an example first device in an environment that includes a second device according to some examples of the disclosure.

FIG. 2 illustrates a block diagram of an example electronic device in accordance with some examples of the disclosure.

FIG. 3 illustrates an example method according to some examples of the disclosure.

FIG. 4 illustrates an example method according to some examples of the disclosure.

### DETAILED DESCRIPTION

In some situations, the sensed information further informs mobile device maintenance and servicing opportunities. Implementations described and claimed herein address the foregoing by providing systems and methods for servicing mobile devices.

In some embodiments, an electronic device operates in an environment including a second electronic device. The electronic device can sense, using one or more sensors, data indicative of acceleration of the second electronic device and can estimate a change in acceleration of the second device that will be caused by the electronic device performing a maneuver. In some embodiments, the first device can perform the maneuver in accordance with a determination that the predicted change in acceleration of the second device satisfies one or more criteria and can forgo performing the maneuver in accordance with a determination that the change in acceleration does not satisfy the one or more criteria.

In some embodiments, an electronic device performs one or more maneuvers according to a movement algorithm. In some embodiments, while the electronic device moves according to the movement algorithm, the electronic device senses, using one or more sensors, data indicative of a change in acceleration of a second electronic device. In some embodiments, in accordance with the change in acceleration satisfying one or more criteria, the electronic device updates the movement algorithm.

While the foregoing and additional implementations are described herein, still other implementations are possible. Modifications within the spirit and scope of the presently disclosed technology are possible. Accordingly, the drawings and detailed description are to be regarded as illustrative in nature.

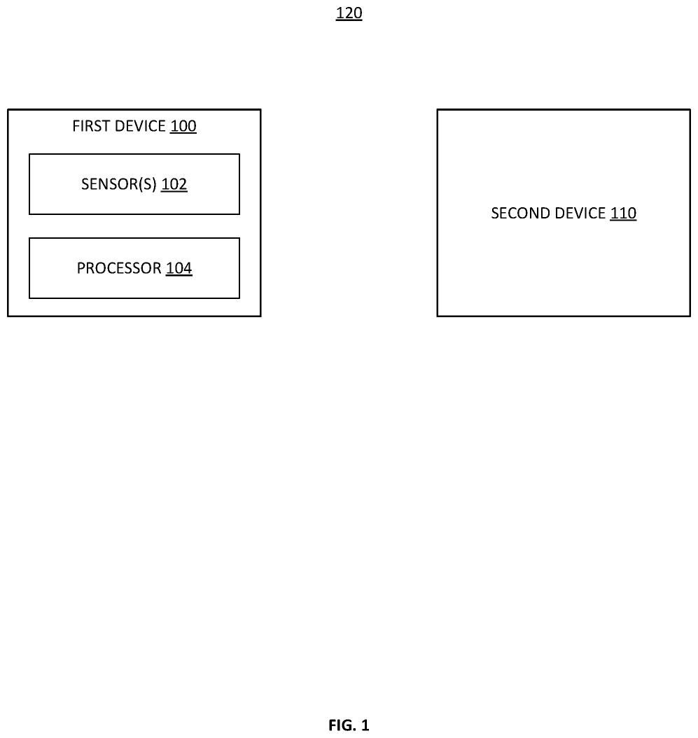

FIG. 1 illustrates an example first device 100 in an environment 120 that includes a second device 110 according to some examples of the disclosure. In some embodiments, the first device 100 includes one or more sensors 102 and one or more processors 104. The device 100 can use the one or more sensors 102 to sense data in the environment 120 of the first device 100 and use that data to perform one or more maneuvers using one or more actuators of the first device 100. For example, the one or more maneuvers include autonomous movement of the first device.

In some embodiments, the one or more sensors can be used to sense the location, speed, and/or acceleration of one or more objects in environment 120, including those of a second device 110. Sensing data with sensors 102 can enable the first device 100 to perform one or more maneuvers while maintaining spacing with one or more objects in the environment 120, including second device 110, for example. In some embodiments, the first device 100 further uses data sensed via the one or more sensors 102 to determine whether or not to perform a maneuver based on a predicted change in acceleration of the second device 110 caused by the first device 100 performing the maneuver. For example, the first device 100 may performing a maneuver after the first device 100 determines, based on data sensed using sensors 102, that performing the maneuver will still allow second device 110 to maintain a trajectory (e.g., acceleration) that is convenient and comfortable to second device 110 and its users.

In some embodiments, the second device 110 can be similar to the first device 100. For example, the second device 110 can include one or more processors, one or more sensors, and/or one or more actuators. In some embodiments, the second device 110 is configured to perform one or more maneuvers in accordance with sensor data. For example, the second device 110 performs the one or more maneuvers according to a motion plan unknown to the first device 100. In some embodiments, the second device 110 is configured to perform maneuvers in response to user commands. It should be understood that the second device 110 is meant to be exemplary. In some embodiments, the first device 100 can operate in an environment that includes a plurality of second devices. In some embodiments, one or more techniques described herein with reference to a second device 110 can be applied to environments including a plurality of second devices 110.

In some embodiments, the first device 100 can perform one or more maneuvers included in a motion plan of the first device 100 using one or more actuators. The first device 100 can determine, using the one or more processors 104, whether or not to perform a maneuver included in the motion plan based on data sensed via the one or more sensors 102 that is indicative of the position, speed, and/or acceleration of the second device 110. In some embodiments, the one or more processors 104 can use the sensed data to estimate how the acceleration of the second device 110 will change in response to the first device 100 performing a maneuver.

In accordance with a determination that an estimated change in the acceleration of the second device 110 caused by the first device 100 performing the maneuver satisfies one or more criteria, the first device 100 can proceed to perform the maneuver using the one or more motion actuators of the first device 100. In some embodiments, the one or more criteria include a criterion that is satisfied based on the estimated amount of change in acceleration of the second device 110 caused by the first device 100 performing the maneuver. For example, if the one or more processors 104 determine that the maneuver will cause the second device 110 to change acceleration by less than a threshold amount, the first device 100 proceeds to perform the maneuver. In some embodiments, the threshold amount is associated with the convenience of ability of the second device 110 to maintain its planned motion. In some embodiments, the threshold amount is associated with the ability of the second device 110 to maintain a comfortable experience for its users.

In some embodiments, the one or more criteria include a criterion related to rules and/or courtesies and/or norms of devices operating in environment 120. For example, if the rules, courtesies, and/or norms allow or obligate the first device 100 to perform the maneuver, the first device 100 may proceed to perform the maneuver, even if doing so would cause the second device 110 to change acceleration at a rate higher than the predetermined threshold described above. In some embodiments, the first device 100 can evaluate whether or not to perform the maneuver based on additional or alternative criteria described in more detail below.

In some embodiments, in accordance with a determination that the estimated change in the acceleration of the second device 110 caused by the first device 100 performing the maneuver does not satisfy the one or more criteria, the first device 100 forgoes performing the maneuver. In some embodiments, the one or more criteria are not satisfied when the estimated amount of change in acceleration of the second device 110 caused by the first device 100 performing the maneuver exceeds the threshold described above. For example, if the one or more processors 104 determine that the maneuver will cause the second device 110 to change acceleration by more than the threshold amount, the first device 100 can forgo performing the maneuver.

In some embodiments, the one or more criteria include a criterion related to rules, courtesies, and/or norms of devices operating in environment 120. For example, if the rules, courtesies, and/or norms indicate that the first device 100 should refrain from the maneuver, the first device 100 forgoes the maneuver, even if doing so would otherwise comport with the above-described acceleration criteria. In some embodiments, after forgoing performing the maneuver, the first device 100 can continue to sense data with the one or more sensors 102 and, in accordance with detecting that the one or more criteria for performing the maneuver are satisfied, the first device 100 can perform the maneuver at a later time.

Thus, in some embodiments, the first device 100 can selectively perform or forgo performing a maneuver in accordance with one or more criteria related to the acceleration of the second device 110 and/or rules, courtesies, and/or norms for devices operating in environment 120. In some embodiments, the one or more criteria capture motion comfort experienced by the second device 110 as a consequence of the first device 100 performing a maneuver. In some embodiments, the one or more criteria capture inconvenience experienced by the second device 110 after the first device 100 performs a maneuver.

In some embodiments, the one or more criteria relate to the impact of the first device 100 performing the maneuver on a change in acceleration of the second device 110. In some situations, the second device 110 may perform a change in acceleration independent from whether or not the first device 100 performs a maneuver. In some embodiments, the first device 100 can predict the change in acceleration of the second electronic device 110 independent from whether or not the first device performs the maneuver and can factor the prediction into the decision whether or not to perform the maneuver. For example, if the first device 100 predicts that performing the maneuver will cause the second device 110 to change acceleration at a rate that exceeds the predefined threshold but that the second device 110 is predicted to change acceleration in this manner irrespective of whether or not the first device 100 performs the maneuver, the first device 100 may perform the maneuver.

In some embodiments, the first device 100 senses, using the one or more sensors 102, second data indicative of a predicted change in acceleration of the second device 110 independent from performance of the maneuver by the electronic device. For example, the second data can include location and/or motion data of the second device 110 and/or sensing one or more additional objects in the environment 120 that may cause the second device 110 to change acceleration.

In some embodiments, in accordance with a determination that the predicted change in acceleration of the second electronic device 110 independent from performance of the maneuver by the first device 100 satisfies one or more second criteria, the first device 100 can perform the maneuver using the one or more motion actuators of the first device 100. In some embodiments, the one or more second criteria can relate to the predicted change in acceleration of the second device 110 independent of performance of the maneuver by the first device 100 being within a threshold amount of the predicted change in acceleration of the second device 110 caused by the first device 100 performing the maneuver. In some embodiments, the one or more second criteria can relate to the predicted change in acceleration of the second device 110 independent of performance of the maneuver by the first device 100 facilitating performance of the maneuver by the first device 100, such as being predicted to cause the second device 110 to move out of a region of the environment 120 to which the first device 100 will move when performing the maneuver.

In some embodiments, in accordance with a determination that the predicted change in acceleration of the second device 110 independent from performance of the maneuver by the first device 100 does not satisfy the one or more second criteria, the first device 100 forgoes performing the maneuver. For example, if the second device 110 is predicted to change acceleration independent from performance of the maneuver by the first device 100 by an amount that is different from the predicted amount of acceleration of the second device 110 caused by performance of the maneuver by the first device 100 by more than a threshold, the first device 100 can forgo performing the maneuver.

As described above, in some embodiments, the first device 100 can predict the change in acceleration of the second device 110 independent from performance of the maneuver by the first device 100 based on second data sensed using the one or more sensors 102. For example, the data can include detecting one or more additional objects in the environment 120 of the first device 100 and the second device 110 that may cause the second device 110 to change acceleration irrespective of whether the first device 100 performs the maneuver. For example, sensing a maneuver performed by a third device or sensing an object that signals the second device 110 to change acceleration to comply with rules, norms, and/or courtesies for operating in the environment 120 can cause the first device 100 to predict that the second device 110 will change acceleration irrespective of whether or not the first device 100 performs the maneuver. In some embodiments, the first device 100 can perform the maneuver even if the maneuver would cause the second device 110 to change acceleration by more than a threshold amount if the first device 100 predicts that the second device 110 will change acceleration in a similar manner anyway.

As described above, in some embodiments, the computer system 100 can evaluate predicted acceleration of the second device 110 caused by the first device 100 performing a maneuver according to one or more criteria when determining whether or not to perform the maneuver. In some situations, the environment 120 can include a plurality of second devices 110 and the computer system can evaluate predicted acceleration of the plurality of second devices according to the one or more criteria when determining whether or not to perform a maneuver. In some embodiments, the first device 100 calculates a sum of the predicted change in acceleration caused by the first device 100 performing the maneuver for each of the plurality of second devices. In accordance with the sum exceeding a threshold, in some embodiments, the first device 100 forgoes performing the maneuver. In some embodiments, in accordance with the sum being less than the threshold, the first device 100 performs the maneuver. In some embodiments, the first device 101 compares the predicted change in acceleration of each of the second devices to a second threshold. In accordance with a determination that the predicted change in acceleration of each second device is less than the second threshold, the first device 100 can perform the maneuver. In accordance with a determination that the predicted change in acceleration for at least one second device exceeds the second threshold, the first device 100 can forgo performing the maneuver.

Thus, as described above, in some embodiments, the first device 100 determines whether or not to perform a maneuver based on a predicted change in acceleration by the second device 110 (or a plurality of second devices) caused by the first device 100 performing the maneuver. In some embodiments, the first device 100 can use similar techniques to train a machine learning algorithm for performing maneuvers by observing the change in acceleration of the second device 110 (or a plurality of second devices) caused by performing a maneuver after the maneuver is performed. In some embodiments, the first device 100 records data related to the environment 120 and the behavior of the second device 110 when the maneuver was performed in association with the change in acceleration of the second device 110 while and/or after the maneuver was performed and uses the data to refine the algorithm used to perform maneuvers in the future, as will be described in more detail below.

In some embodiments, the first device 100 operates in environment 120, including performing a maneuver according to a movement algorithm. The movement algorithm optionally controls movement of the first device 100 according to an objective and/or data about the environment 120, including the location/speed/acceleration of the second device 110. For example, the first device 100 uses the movement algorithm to perform one or more maneuvers to move the first device 100 from one location to another without interfering with the second device 110 as described above. In some situations, the first device 100 can update the movement algorithm in accordance with data sensed during operation of the first device 100 according to the movement algorithm.

In some embodiments, while the one or more processors 104 cause movement of the first device 100 based on first data sensed using the sensors 102 and the movement algorithm, the one or more processors 104 use the one or more sensors 102 to sense second data indicative of a change in acceleration of the second device 110 while and/or after the first device 100 performs a maneuver according to the movement algorithm. The first device 100 optionally determines, based on the second data, a change in acceleration of the second device 110 caused by the first device 100 performing the maneuver. In some embodiments, in accordance with a determination that the change in acceleration of the second device 100 satisfies one or more criteria described in more detail below, the first device 100 updates the movement algorithm. In some embodiments, the one or more criteria being satisfied is associated with the change in acceleration of the second device 110 caused by the first device 100 performing the maneuver being higher than a threshold. In some embodiments, if the change in acceleration of the second device 110 satisfies the one or more criteria, the first device 100 updates the algorithm, for example adjusting thresholds, to improve future processing.

As described above, in some embodiments, the first device 100 determines whether or not to update the movement algorithm by evaluating the change in acceleration of the second device 110 according to one or more criteria. In some embodiments, the one or more criteria include a criterion that is satisfied when the change in acceleration exceeds a threshold amount. In some situations, however, the second device 110 may change acceleration independent from performance of the maneuver by the first device 100. Thus, in some embodiments, the one or more criteria include criteria that can help the first device 100 evaluate whether or not the change in acceleration of the second device 110 was caused by the first device 100 performing the maneuver or caused by other objects and/or circumstances.

For example, the first device 100 can evaluate whether the environment 120 includes other objects that may cause the second device 110 to change acceleration, as described above. In some embodiments, the first device 100 can evaluate an expected change in acceleration of the second device 110 caused by the other objects in the environment 120 to estimate a portion and/or amount of the change in acceleration that was caused by the first device 110 performing the maneuver. The first device 100 optionally evaluates the portion of the change in acceleration of the second device 110 according to the one or more criteria and disregards the portion of the change in acceleration of the second device 110 caused by other objects. For example, if the second device 110 changes acceleration by an amount that exceeds a predefined threshold amount included in the one or more criteria, the first device 100 will forgo updating the movement algorithm in accordance with a determination that the portion of the change in acceleration caused by other objects is large enough that the change in acceleration caused by the first device 100 performing the maneuver is less than the predefined threshold.

Moreover, as described above, in some embodiments, the one or more criteria can include exceptions based on rules and/or courtesies and/or norms of devices operating in the environment 120. For example, if the rules, courtesies, and/or norms obligated the first device 100 to perform the maneuver, the first device 100 may forgo updating the movement algorithm even if the change in acceleration of the second device 110 satisfies one or more other criteria of the one or more criteria. As another example, if the rules, courtesies, and/or norms obligated the second device 110 to change acceleration by a respective amount, the first device 100 can disregard that amount of acceleration when analyzing the change in acceleration of the second device 110. For example, even if the change in acceleration of the second device 110 satisfies one or more of the criteria, if the portion of the change of acceleration that was caused by the first device 100 performing the maneuver does not satisfy the one or more criteria, the first device 100 forgoes updating the movement algorithm.

In some embodiments, the environment 120 includes a plurality of second devices 110 and the first device 100 evaluates the change in acceleration for the plurality of second devices 110 when determining whether or not to update the movement algorithm. In some embodiments, the one or more second devices 110 are in motion in the environment 120 according to motion plans that are unknown to the first device 100. In some embodiments, the first device 100 senses movement of the one or more second devices 110 using sensor(s) 102. In some embodiments, the first device 100 evaluates the changes in acceleration for the plurality. For example, the first device 100 calculates a sum and/or average and/or median change in acceleration of the second devices caused by the first device 100 performing the maneuver and compares this value to a threshold amount. In some embodiments, if the value exceeds the threshold, the first device 100 updates the movement algorithm and if the value is less than the threshold, the first device 100 forgoes updating the movement algorithm. In some embodiments, rather than calculating a sum and/or average and/or median change in acceleration of the second devices caused by the first device 100 performing the maneuver, the first device 100 compares the change in acceleration caused by the first device 100 performing the maneuver for each of the second devices and compares each of these values to a predetermined threshold amount. For example, if at the change in acceleration caused by the first device 100 performing the maneuver at one or more of the second device 110 exceeds the threshold (even if the change in acceleration for one or more other second devices 110 does not exceed the threshold), the first device 100 updates the movement algorithm.

In some embodiments, the movement algorithm includes estimating a change in acceleration of the second device 110 that will be caused by the first device 100 performing a respective maneuver. As described above, in some embodiments, the first device 100 can determine whether or not to perform the maneuver based on the predicted change in acceleration of the second device 110 caused by the first device 100 performing the maneuver. For example, the first device 100 can decide to perform the maneuver based on the predicted change in acceleration of the second device 110 caused by the first device 100 performing the maneuver satisfying one or more first criteria. In some embodiments, while and/or after performing the maneuver, the first device 100 can determine the change in acceleration of the second device 110 that was caused by the first device 100 performing the maneuver. In some embodiments, the first device 100 can update the movement algorithm to improve estimation of the change in acceleration of the second device as described in more detail above.

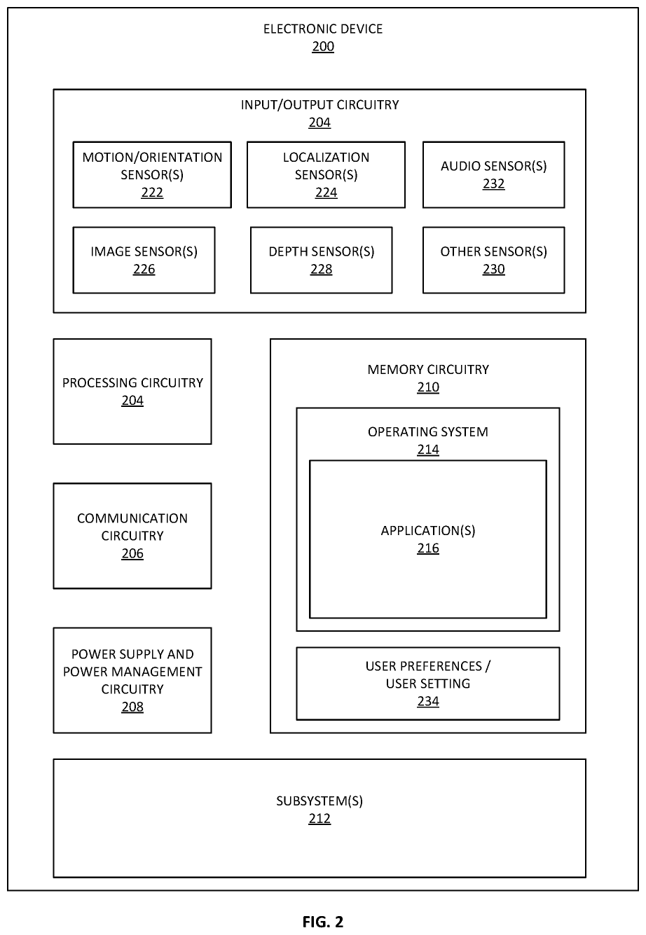

FIG. 2 illustrates a block diagram of an example electronic device 200 in accordance with some examples of the disclosure. Electronic device 200 can represent any of the electronic devices 100 or 110 in FIG. 1 shown in more detail. It is understood that the block diagram of FIG. 2 includes one example architecture, but that a different electronic device may have more or fewer components and/or a different configuration of components than shown in FIG. 2. Various components of FIG. 2 can be implemented in hardware, software, firmware or combinations thereof.

As illustrated, FIG. 2 can include input/output circuitry 202, processing circuitry 204, communication circuitry 206, power supply and power management circuitry 208, memory circuitry 210 and one or more subsystems 212. Although not shown in FIG. 2, the various components can be electrically coupled by one or more buses and/or using one or more interfaces and electrical connections.

Input/output circuitry 202 can include devices for providing input to the electronic device 200 and for providing output from the electronic devices. In some examples, input/output circuitry 202 can include sensors such as motion and/or orientation sensor(s) 222, localization sensor(s) 224, image sensor(s) 226, depth sensor(s) 228, audio sensor(s) 232, and other sensor(s) 230.

Motion and/or orientation sensor(s) 222 can include one or more accelerometers, gyroscopes, and/or inertial measurement units (IMUs) to measure motion and/or orientation of electronic device 200. Localization sensor(s) 224 may be used to determine location, heading, and/or orientation of electronic device 200. The localization sensor(s) 224 or localization system(s) can including global navigation satellite system (GNSS) or sensor, inertial navigation system (INS) or sensor, global positioning system (GPS) or sensor, altitude and heading reference system (AHRS) or sensor, compass, etc. Image sensor(s) 226 and depth sensor(s) 228 can include sensors to generate two-dimensional or three-dimensional images, radio detection and ranging sensors or systems, light detection and ranging sensors or systems, visual or video detection and ranging sensors or systems, infrared (IR) sensors, optical sensors, camera sensors (e.g., color or grayscale), etc. Audio sensor(s) 232 can include one or more microphones, optionally arranged in an array. In some examples, input/output circuitry 202 can include output devices, such as speaker(s), display(s), or haptic output devices that can provide audio, visual, and/or tactile feedback to a user. It is understood that additional input/output devices can be included in the electronic devices described herein, such as a keyboard, a mouse, a button, a slider, a touch sensor or touch sensor panel, a wheel, a touchpad, a trackpad, a touch screen, a joystick, a proximity sensor, a switch, etc.

Processing circuitry 204 can include one or more processors including microcontrollers, microprocessors, application specific integrated circuits (ASICs), programmable logic device (PLD), field-programmable gate arrays (FPGAs), central processing units (CPUs), graphics processing units (GPUs), digital signal processors (DSPs), or any suitable processing circuitry. Processing circuitry 204 can be used to perform any of the processes, methods, or functions described herein (e.g., optionally by executing instructions or programs stored in a non-transitory computer-readable storage medium). Some example functions include environmental perception (e.g., sensing and identifying objects in the environment of the first device), motion planning for facilitating movement of the first device, and/or predictive actions.

Communication circuitry 206 can include circuitry to provide for wired or wireless communication with other electronic devices. In some examples, the communication circuitry can enable communication using different communication protocols such as WiFi, Bluetooth, Zigbee, cellular, satellite, etc. In some examples, the communication circuitry can include one or more transmitter and/or receiver antennas to transmit and/or receive data from one or more data sources for use in predictive actions as described herein.

In some examples, power supply and power management circuitry 208 can include one or more energy storage device(s) (e.g., a battery or multiple batteries) to provide a power supply for the powered components of electronic device 200. In some examples, power supply and power management circuitry 208 can include circuitry for wired or wireless charging of the one or more energy storage device(s). In some examples, the power supply and power management circuitry 208 can include circuitry to manage power delivery and usage by the components of electronic device 200, to manage charging of the one or more energy storage device(s), and/or to monitor the energy levels of the one or more energy storage devices.

Memory circuitry 210 can include any suitable type of memory including but not limited to volatile or non-volatile memory (e.g., where data may be maintained after all power is removed from electronic device 200). Memory circuitry 210 can include any suitable electronic, magnetic, optical, electromagnetic, infrared, or semiconductor system, apparatus or device. The memory circuitry can include, but is not limited to, flash memory devices, random access memory (RAM) devices (e.g., dynamic random-access memory (DRAM), static random-access memory (SRAM), double-data-rate random-access memory (DDR RAM), or other high-speed RAM or solid-state RAM, etc.), read-only memory (ROM) devices, or erasable or electrically erasable programmable read-only memory devices (EPROM or EEPROM). In some examples, some of memory circuitry 210 can be integrated within other components of electronic device 200. In some examples, memory circuitry 210 can be separate from the one or more other components of electronic device 200 and electrically coupled for read and/or write operations.

In some examples, the memory circuitry 210 or a subset of the memory circuitry 210 can be referred as a computer-readable storage medium. Memory circuitry 210 and/or the non-transitory computer readable storage medium of memory circuitry 210 can store programs, instructions, data modules, data structures or a subset or combination thereof. In some examples, Memory circuitry 210 and/or the non-transitory computer readable storage medium can store an operating system 214. In some examples, the operating system 214 can manage one or more running applications 216 (e.g., by scheduling the electronic device 200 to execute the applications 216 using one or multiple processing cores). Additionally, memory circuitry 210 and/or non-transitory computer readable storage medium can have programs/instructions stored therein, which when executed by processing circuitry, can cause the electronic device 200 (or the computing system 200 more generally) to perform one or more functions and methods of one or more examples of this disclosure (e.g., determining whether or not to perform a maneuver and/or whether or not to update a movement algorithm of the device). As used herein, a “non-transitory computer-readable storage medium” can be any medium (e.g., excluding signals) that can contain or store programs/instructions for use by the electronic device (e.g., processing circuitry).

Subsystems 212 can include any additional subsystems for electronic device 200. For some mobile devices, subsystems 212 can include, without limitation, motor controllers and systems, additional or alternative actuators, light systems, navigation systems, entertainment systems, and the like.

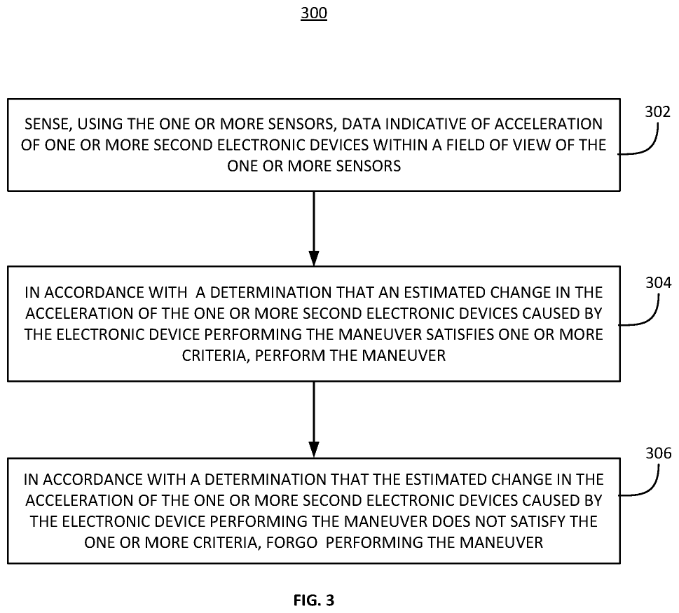

FIG. 3 illustrates an example method 300 according to some examples of the disclosure. In some examples, method 300 can be performed by first device 100 and/or electronic device 200 described above with reference to FIGS. 1 and 2. In some examples, the first device includes one or more sensors (e.g., camera(s), depth sensor(s), microphone(s), vibration sensor(s), localization sensor(s), etc.) configured to perform a plurality of first operations. In some examples, a transitory or non-transitory computer-readable storage medium can store instructions that, when executed by one or more processors of a mobile device, can cause the mobile device to perform one or more operations of method 300. In some examples, one or more operations of method 300 can be changed, removed, repeated, and/or modified without departing from the scope of the disclosure.

In some embodiments, the electronic device 100 senses (302), using the one or more sensors 102, data indicative of acceleration of one or more second electronic devices 110 within a field of view of the one or more sensors 102. In some embodiments, in accordance with a determination that an estimated change in the acceleration of the one or more second electronic devices 110 caused by the electronic device 100 performing the maneuver satisfies one or more criteria, the electronic device 100 performs (304) a maneuver using one or more motion actuators of the electronic device 100. In some embodiments, in accordance with a determination that the estimated change in the acceleration of the one or more second electronic devices 110 caused by the electronic device 100 performing the maneuver does not satisfy the one or more criteria, the electronic device 100 forgoes (306) performing the maneuver.

In some embodiments, the one or more processors are further configured to sense, using the one or more sensors, second data indicative of a predicted change in acceleration of the one or more second electronic devices independent from performance of the maneuver by the electronic device. In some embodiments, the one or more processors are further configured to, in accordance with a determination that the predicted change in acceleration of the one or more second electronic devices independent from performance of the maneuver by the electronic device satisfies one or more second criteria, perform the maneuver using the one or more motion actuators of the electronic device.

In some embodiments, sensing the second data includes detecting an object predicted to cause the predicted change in the acceleration of the one or more second electronic devices independent from performance of the maneuver by the electronic device.

In some embodiments, the one or more second electronic devices are a plurality of electronic devices. In some embodiments, the determination that the estimated change in the acceleration of the one or more second electronic devices caused by the electronic device performing the maneuver satisfies the one or more criteria comprises a determination that the estimated change in the acceleration of the plurality of second electronic devices caused by the electronic device performing the maneuver satisfies the one or more criteria. In some embodiments, the determination that the estimated change in the acceleration of the one or more second electronic devices caused by the electronic device performing the maneuver does not satisfy the one or more criteria comprises a determination that the estimated change in the acceleration of the plurality of second electronic devices caused by the electronic device performing the maneuver does not satisfy the one or more criteria.

In some embodiments, the determination that the estimated change in the acceleration of the plurality of second electronic devices caused by the electronic device performing the maneuver satisfies the one or more criteria is in accordance with a sum of the one or more criteria for the plurality of second electronic devices satisfying a predetermined threshold. In some embodiments, the determination that the estimated change in the acceleration of the plurality of second electronic devices caused by the electronic device performing the maneuver does not satisfy the one or more criteria is in accordance with a sum of the one or more criteria for the plurality of second electronic devices not satisfying the predetermined threshold.

In some, the determination that the estimated change in the acceleration of the plurality of second electronic devices caused by the electronic device performing the maneuver satisfies the one or more criteria is in accordance with the one or more criteria for the plurality of second electronic devices being satisfied. In some embodiments, the determination that the estimated change in the acceleration of the plurality of second electronic devices caused by the electronic device performing the maneuver does not satisfy the one or more criteria is in accordance with the one or more criteria for at least one the plurality of second electronic devices not being satisfied.

In some embodiments, forgoing performing the maneuver in accordance with a determination that the estimated change in the acceleration of the one or more second electronic devices caused by the electronic device performing the maneuver does not satisfy the one or more criteria is in accordance with a determination that performing the maneuver does not satisfy one or more second criteria independent from the one or more criteria. In some embodiments, the one or more processors are further configured to, in accordance with the determination that the estimated change in the acceleration of the one or more second electronic devices caused by the electronic device performing the maneuver does not satisfy the one or more criteria, in accordance with a determination that performing the maneuver satisfies the one or more second criteria, perform the maneuver using the one or more motion actuators of the electronic device.

In some embodiments, while the electronic device senses the data, the one or more second electronic devices are in motion according to one or more motion plans unknown to the electronic device.

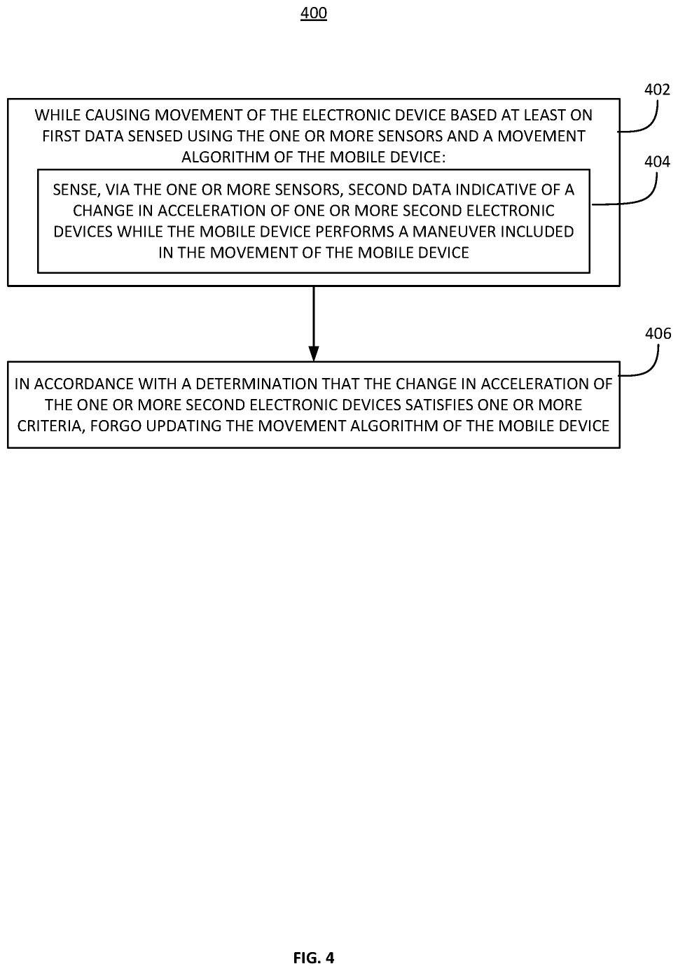

FIG. 4 illustrates an example method 400 according to some examples of the disclosure. In some examples, method 400 can be performed by first device 100 and/or electronic device 200 described above with reference to FIGS. 1 and 2. In some examples, the device includes one or more sensors (e.g., camera(s), depth sensor(s), microphone(s), vibration sensor(s), localization sensor(s), etc.) configured to perform a plurality of first operations. In some examples, a transitory or non-transitory computer-readable storage medium can store instructions that, when executed by one or more processors of a charger, can cause the charger to perform one or more operations of method 400. In some examples, one or more operations of method 400 can be changed, removed, repeated, and/or modified without departing from the scope of the disclosure.

In some embodiments, while causing movement of the electronic device 100 based at least on first data sensed using the one or more sensors 102 and a movement algorithm of the electronic device 100 (402), the electronic device 100 senses (404), using the one or more sensors (404), second data indicative of a change in acceleration of one or more second electronic devices 110 while the electronic device 100 performs a maneuver included in the movement of the electronic device 100. In some embodiments, in accordance with a determination that the change in acceleration of the one or more second electronic devices (110) satisfies one or more criteria, the electronic device 100 updates (406) the movement algorithm of the electronic device 100.

In some embodiments, updating the movement algorithm of the electronic device includes updating the movement algorithm to forgo performing the maneuver in accordance with third data sensed using the one or more sensors corresponding to the first data.

In some embodiments, the one or more criteria include a criterion that is satisfied when a portion of the change in acceleration estimated to be caused by the electronic device performing the maneuver exceeds a threshold. In some embodiments, the one or more criteria are independent from a portion of the change in acceleration estimated to be caused by an object other than the electronic device performing the maneuver.

In some embodiments, the one or more second electronic devices are a plurality of electronic devices. In some embodiments, the determination that the change in the acceleration of the one or more second electronic devices satisfies the one or more criteria is a determination that the change in the acceleration of the plurality of second electronic devices satisfies the one or more criteria.

In some embodiments, the determination that the change in the acceleration of the plurality of second electronic devices satisfies the one or more criteria is in accordance with a sum of the one or more criteria for the plurality of second electronic devices satisfying a predetermined threshold. In some embodiments, in accordance with the sum of the one or more criteria for the plurality of second electronic devices not satisfying the predetermined threshold, the one or more criteria are not satisfied.

In some embodiments, in accordance with the one or more criteria for at least one of the plurality of second electronic devices not being satisfied, the one or more criteria are not satisfied.

In some embodiments, the one or more processors are configured to, in accordance with the determination that the change in acceleration of the one or more second devices satisfies the one or more criteria, in accordance with a determination that one or more second criteria different from the one or more criteria are satisfied, forgo updating the movement algorithm.

In some embodiments, the one or more second electronic devices are in motion according to one or more motion plans unknown to the electronic device.

In some embodiments, the one or more processors are further configured to, while causing movement of the electronic device based at least on first data sensed using the one or more sensors and a movement algorithm of the electronic device and prior to performing the maneuver, estimate, based on the first data, a predicted change in acceleration of the one or more second electronic devices caused by the electronic device performing the maneuver. In some embodiments, the one or more criteria include a criterion that is satisfied when a difference between the change in acceleration of the one or more second electronic devices and the predicted change in acceleration of the one or more second electronic devices caused by the electronic device performing the maneuver is greater than a predetermined threshold.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order and are not necessarily meant to be limited to the specific order or hierarchy presented. The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer).

It should be understood that the processing and/or storing of data (e.g., sensor data) should be performed in accordance with privacy practice(s) in accordance with local laws and/or industry privacy practices and standards. These privacy practices may include, but are not limited to, requiring user permission to share the data and/or permitting the user to opt-out of processing and/or storing some or all of the data and/or anonymizing the data, and so forth.

1. An electronic device, comprising:
one or more sensors; and
one or more processors configured to:
sense, using the one or more sensors, data indicative of acceleration of one or more second electronic devices within a field of view of the one or more sensors;
in accordance with a determination that an estimated change in the acceleration of the one or more second electronic devices caused by the electronic device performing a maneuver satisfies one or more criteria, perform the maneuver using one or more motion actuators of the electronic device; and
in accordance with a determination that the estimated change in the acceleration of the one or more second electronic devices caused by the electronic device performing the maneuver does not satisfy the one or more criteria, forgo performing the maneuver.

2. The electronic device of claim 1, wherein the one or more processors are further configured to:
sense, using the one or more sensors, second data indicative of a predicted change in acceleration of the one or more second electronic devices independent from performance of the maneuver by the electronic device; and
in accordance with a determination that the predicted change in acceleration of the one or more second electronic devices independent from performance of the maneuver by the electronic device satisfies one or more second criteria, perform the maneuver using the one or more motion actuators of the electronic device.

3. The electronic device of claim 2, wherein sensing the second data includes detecting an object predicted to cause the predicted change in the acceleration of the one or more second electronic devices independent from performance of the maneuver by the electronic device.

4. The electronic device of claim 1, wherein:
the one or more second electronic devices are a plurality of electronic devices, and
the determination that the estimated change in the acceleration of the one or more second electronic devices caused by the electronic device performing the maneuver satisfies the one or more criteria comprises a determination that the estimated change in the acceleration of the plurality of second electronic devices caused by the electronic device performing the maneuver satisfies the one or more criteria, and
the determination that the estimated change in the acceleration of the one or more second electronic devices caused by the electronic device performing the maneuver does not satisfy the one or more criteria comprises a determination that the estimated change in the acceleration of the plurality of second electronic devices caused by the electronic device performing the maneuver does not satisfy the one or more criteria.

5. The electronic device of claim 4, wherein:
the determination that the estimated change in the acceleration of the plurality of second electronic devices caused by the electronic device performing the maneuver satisfies the one or more criteria is in accordance with a sum of the one or more criteria for the plurality of second electronic devices satisfying a predetermined threshold, and
the determination that the estimated change in the acceleration of the plurality of second electronic devices caused by the electronic device performing the maneuver does not satisfy the one or more criteria is in accordance with a sum of the one or more criteria for the plurality of second electronic devices not satisfying the predetermined threshold.

6. The electronic device of claim 4, wherein:
the determination that the estimated change in the acceleration of the plurality of second electronic devices caused by the electronic device performing the maneuver satisfies the one or more criteria is in accordance with the one or more criteria for the plurality of second electronic devices being satisfied, and
the determination that the estimated change in the acceleration of the plurality of second electronic devices caused by the electronic device performing the maneuver does not satisfy the one or more criteria is in accordance with the one or more criteria for at least one the plurality of second electronic devices not being satisfied.

7. The electronic device of claim 1, wherein forgoing performing the maneuver in accordance with a determination that the estimated change in the acceleration of the one or more second electronic devices caused by the electronic device performing the maneuver does not satisfy the one or more criteria is in accordance with a determination that performing the maneuver does not satisfy one or more second criteria independent from the one or more criteria, and the one or more processors are further configured to:
in accordance with the determination that the estimated change in the acceleration of the one or more second electronic devices caused by the electronic device performing the maneuver does not satisfy the one or more criteria, in accordance with a determination that performing the maneuver satisfies the one or more second criteria, perform the maneuver using the one or more motion actuators of the electronic device.

8. The electronic device of claim 1, wherein:
while the electronic device senses the data, the one or more second electronic devices are in motion according to one or more motion plans unknown to the electronic device.

9. A method performed at an electronic device including one or more sensors and one or more processors, the method comprising:
sensing, using the one or more sensors, data indicative of acceleration of one or more second electronic devices within a field of view of the one or more sensors;
in accordance with a determination that an estimated change in the acceleration of the one or more second electronic devices caused by the electronic device performing a maneuver satisfies one or more criteria, performing the maneuver using one or more motion actuators of the electronic device; and
in accordance with a determination that the estimated change in the acceleration of the one or more second electronic devices caused by the electronic device performing the maneuver does not satisfy the one or more criteria, forgoing performing the maneuver.

10. The method of claim 9, further comprising:
sensing, using the one or more sensors, second data indicative of a predicted change in acceleration of the one or more second electronic devices independent from performance of the maneuver by the electronic device; and
in accordance with a determination that the predicted change in acceleration of the one or more second electronic devices independent from performance of the maneuver by the electronic device satisfies one or more second criteria, performing the maneuver using the one or more motion actuators of the electronic device.

11. The method of claim 9, wherein:
the one or more second electronic devices are a plurality of electronic devices, and
the determination that the estimated change in the acceleration of the one or more second electronic devices caused by the electronic device performing the maneuver satisfies the one or more criteria comprises a determination that the estimated change in the acceleration of the plurality of second electronic devices caused by the electronic device performing the maneuver satisfies the one or more criteria, and
the determination that the estimated change in the acceleration of the one or more second electronic devices caused by the electronic device performing the maneuver does not satisfy the one or more criteria comprises a determination that the estimated change in the acceleration of the plurality of second electronic devices caused by the electronic device performing the maneuver does not satisfy the one or more criteria.

12. The method of claim 9, wherein forgoing performing the maneuver in accordance with a determination that the estimated change in the acceleration of the one or more second electronic devices caused by the electronic device performing the maneuver does not satisfy the one or more criteria is in accordance with a determination that performing the maneuver does not satisfy one or more second criteria independent from the one or more criteria, the method further comprising:
in accordance with the determination that the estimated change in the acceleration of the one or more second electronic devices caused by the electronic device performing the maneuver does not satisfy the one or more criteria, in accordance with a determination that performing the maneuver satisfies the one or more second criteria, performing the maneuver using the one or more motion actuators of the electronic device.

13. A non-transitory computer readable storage medium storing one or more programs, the one or more programs comprising instructions, which when executed by one or more processors of an electronic device that further includes one or more sensors, cause the electronic device to perform a method comprising:
sensing, using the one or more sensors, data indicative of acceleration of one or more second electronic devices within a field of view of the one or more sensors;
in accordance with a determination that an estimated change in the acceleration of the one or more second electronic devices caused by the electronic device performing a maneuver satisfies one or more criteria, performing the maneuver using one or more motion actuators of the electronic device; and
in accordance with a determination that the estimated change in the acceleration of the one or more second electronic devices caused by the electronic device performing the maneuver does not satisfy the one or more criteria, forgoing performing the maneuver.

14. The non-transitory computer readable storage medium of claim 13, wherein the method further comprises:
sensing, using the one or more sensors, second data indicative of a predicted change in acceleration of the one or more second electronic devices independent from performance of the maneuver by the electronic device; and
in accordance with a determination that the predicted change in acceleration of the one or more second electronic devices independent from performance of the maneuver by the electronic device satisfies one or more second criteria, performing the maneuver using the one or more motion actuators of the electronic device.

15. The non-transitory computer readable storage medium of claim 14, wherein sensing the second data includes detecting an object predicted to cause the predicted change in the acceleration of the one or more second electronic devices independent from performance of the maneuver by the electronic device.

16. The non-transitory computer readable storage medium of claim 13, wherein:
the one or more second electronic devices are a plurality of electronic devices, and
the determination that the estimated change in the acceleration of the one or more second electronic devices caused by the electronic device performing the maneuver satisfies the one or more criteria comprises a determination that the estimated change in the acceleration of the plurality of second electronic devices caused by the electronic device performing the maneuver satisfies the one or more criteria, and
the determination that the estimated change in the acceleration of the one or more second electronic devices caused by the electronic device performing the maneuver does not satisfy the one or more criteria comprises a determination that the estimated change in the acceleration of the plurality of second electronic devices caused by the electronic device performing the maneuver does not satisfy the one or more criteria.

17. The non-transitory computer readable storage medium of claim 16, wherein:
the determination that the estimated change in the acceleration of the plurality of second electronic devices caused by the electronic device performing the maneuver satisfies the one or more criteria is in accordance with a sum of the one or more criteria for the plurality of second electronic devices satisfying a predetermined threshold, and
the determination that the estimated change in the acceleration of the plurality of second electronic devices caused by the electronic device performing the maneuver does not satisfy the one or more criteria is in accordance with a sum of the one or more criteria for the plurality of second electronic devices not satisfying the predetermined threshold.

18. The non-transitory computer readable storage medium of claim 16, wherein:
the determination that the estimated change in the acceleration of the plurality of second electronic devices caused by the electronic device performing the maneuver satisfies the one or more criteria is in accordance with the one or more criteria for the plurality of second electronic devices being satisfied, and
the determination that the estimated change in the acceleration of the plurality of second electronic devices caused by the electronic device performing the maneuver does not satisfy the one or more criteria is in accordance with the one or more criteria for at least one the plurality of second electronic devices not being satisfied.

19. The non-transitory computer readable storage medium of claim 13, wherein forgoing performing the maneuver in accordance with a determination that the estimated change in the acceleration of the one or more second electronic devices caused by the electronic device performing the maneuver does not satisfy the one or more criteria is in accordance with a determination that performing the maneuver does not satisfy one or more second criteria independent from the one or more criteria, and the method further comprises:
in accordance with the determination that the estimated change in the acceleration of the one or more second electronic devices caused by the electronic device performing the maneuver does not satisfy the one or more criteria, in accordance with a determination that performing the maneuver satisfies the one or more second criteria, performing the maneuver using the one or more motion actuators of the electronic device.

20. The non-transitory computer readable storage medium of claim 13, wherein:
while the electronic device senses the data, the one or more second electronic devices are in motion according to one or more motion plans unknown to the electronic device.
